(19) United States
(12) Patent Application Publication
(10) Pub. No.: US 2025/0118133 A1
(43) Pub. Date: Apr. 10, 2025

(54) INTERACTIVE ROULETTE INTERFACE AND GAMEPLAY WITH MULTIPLIERS

(71) Applicant: Interblock d.o.o., Menges (SI)

(72) Inventors: John Joseph Connelly, Las Vegas, NV (US); James Preston, Macau (MO); Tomaz Fink, Kamnik (SI)

(21) Appl. No.: 18/890,656

(22) Filed: Sep. 19, 2024

Related U.S. Application Data
(60) Provisional application No. 63/588,946, filed on Oct. 9, 2023.

(51) Int. Cl. G07F 17/32

(52) U.S. Cl. CPC G07F 17/3211

(57) ABSTRACT

The present disclosure relates to systems and methods for roulette gaming systems including an automated roulette wheel and a plurality of player stations having a display providing a gaming interface to wager on roulette gaming events at the automated roulette wheel. Embodiments may include a computing device to provide the gaming interface, set a betting window, receive at least one bet from a player station, determine a type of roulette ball (e.g., normal or multiplier) to be launched into the roulette wheel for the gaming event, a random set of symbols and a separate multiplier value for each symbol in the set of symbols. Payouts are based on the result of the roulette event, and when the result is a symbol in the set of symbols, the multiplier value associated with the symbol.

### CROSS REFERENCE TO RELATED APPLICATIONS

This application claims benefit under 35 U.S.C. § 119(e) of Provisional U.S. Patent Application No. 63/588,946, filed Oct. 9, 2023, the contents of which is incorporated herein by reference in its entirety.

### TECHNICAL FIELD

The present disclosure relates generally, but not exclusively, to the field of gaming, particularly electronic table games.

### BACKGROUND INFORMATION

Casinos offer a variety of games to attract players. Such games may include live table games (e.g., roulette, craps, blackjack, etc.), virtual games, physical machines (e.g., slot-like machines and electronic table games), individual player machines, stadium-style group stations, and various gameplay combinations.

Traditional roulette tables require a highly skilled dealer to manage gaming events. A dealer must supervise and manage bets from one or more players, operate the roulette wheel, determine payouts based on the outcome, and address any disputes or technical issues that arise. As a result, the player to dealer ratio is typically 5:1 or 6:1 for roulette games. The player to dealer ratio can be a limiting factor for roulette tables and gaming locations that have a high demand and multiple players waiting to play. A live dealer also comes with the potential for human error and payout mistakes, such as where a losing bet is accidentally paid out or more is paid on a winning bet than should have been paid. Casinos and gaming locations operating roulette tables and live table games must therefore innovate to attract and retain players, maintain profitability, and improve player experience.

### SUMMARY

An embodiment is directed to a roulette gaming system including an automated roulette wheel configured to launch a roulette ball and determine a result, a plurality of player stations arranged around a perimeter of the automated roulette wheel and having a display, and at least one computing device in communication with the automated roulette wheel and the plurality of player stations. The computing device may include a processor and a memory having instructions to be executed by the processor, and cause the computing device to provide, on a first display of a first player station, a gaming interface to enable a player to wager on roulette events at the automated roulette wheel, wherein the gaming interface provides betting layout for a first roulette gaming event, and wherein the betting layout comprises available outcomes associated with the automated roulette wheel, set a betting window defining a time to accept bets from the plurality player stations, receive, via a selection at the first player station, a first bet wagering on an outcome of a first roulette event, determine a type of roulette ball queued to be launched for the first roulette event, determine a set of symbols on the betting layout to be associated with a multiplier value from a predetermined set of multipliers, when the type of roulette ball is determined to be a standard roulette ball: for each symbol in the set of symbols, determine a multiplier value from a predetermined set of multipliers associated with a first paytable, when the type of roulette ball is determined to be a multiplier ball: for each symbol in the set of symbols, determine a multiplier value from a predetermined set of multipliers associated with a second paytable, indicate, on the gaming interface, the set of symbols and the multiplier value for each symbol, launch the roulette ball to determine the result, and determine a payout for the first bet based on the result and, when the result is a symbol in the set of symbols, the multiplier value associated with the symbol.

These and other features will be more clearly understood from the following detailed description taken in conjunction with the accompanying drawings and claims. This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

### BRIEF DESCRIPTION OF THE DRAWINGS

FIG. 1 is an example of a roulette gaming system, in accordance with an embodiment.

FIG. 2 is an example gaming interface for a standard roulette event, in accordance with an embodiment.

FIG. 3 is an example gaming interface for a multiplier roulette event, in accordance with an embodiment.

FIG. 4 is an example game flow for a roulette gaming event, in accordance with an embodiment.

FIG. 5 is an illustration of an exemplary block diagram representing a general-purpose computer system in which aspects of the methods and systems disclosed herein or portions thereof may be incorporated.

### DETAILED DESCRIPTION OF EMBODIMENTS

The present disclosure describes particular embodiments and their detailed construction and operation. The embodiments described herein are set forth by way of illustration only and not limitation. Those skilled in the art will recognize, in light of the teachings herein, that there may be a range of equivalents to the exemplary embodiments described herein. Most notably, other embodiments are possible, variations can be made to the embodiments described herein, and there may be equivalents to the components, parts, or steps that make up the described embodiments. For the sake of clarity and conciseness, certain aspects of components or steps of certain embodiments are presented without undue detail where such detail would be apparent to those skilled in the art in light of the teachings herein and/or where such detail would obfuscate an understanding of more pertinent aspects of the embodiments.

Disclosed herein are methods, systems, and non-transitory computer readable storage media that provide a live electronic table game (ETG) for roulette. According to an example, a live roulette game may include a main game and a feature game. In the main game, after a betting window for a round has closed, a set of symbols (e.g., numbers) are selected and illustrated on-screen in an animation on a betting layout. For example, the numbers may be shown on-screen in a reel or a reel animation. Each symbol in the set of symbols may be associated with a multiplier determined randomly, based on a first paytable. A roulette outcome of one of the set of symbols will result in a payout multiplied by the multiplier value. A roulette outcome of any of the other symbols on the betting layout may have an increased base pay, such as 30:1.

In a feature game, such as a “Golden Ball” game as described herein, a gaming interface may change colors, designs, animations, etc., to indicate that a special feature game has been initiated. The feature game may be triggered when a special roulette ball is queued to be launched next. After betting windows close and the type of roulette ball is determined to be a special roulette ball, such as a golden ball, the betting layout color and felt may change. An animation may expand across the screen to indicate the set of symbols and assigned multiplier values, which are randomly determined and based off a second paytable different than the first paytable associated with the standard game. A roulette outcome of any of the other symbols on the betting layout may have an increased base pay, such as 40:1.

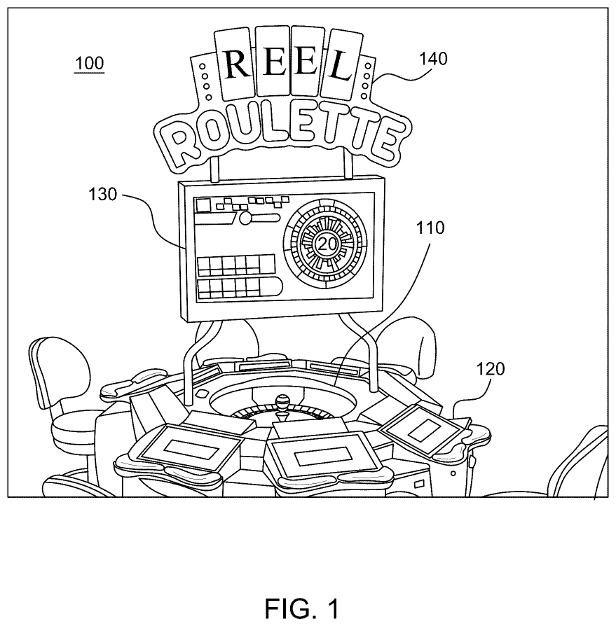

FIG. 1 illustrates an example roulette gaming system 100 including an automated roulette wheel 110, a plurality of player stations 120 surrounding the automated roulette wheel, a display 130 providing information about the automated roulette wheel and gaming events, and signage 140 to advertise the roulette gaming system and attract players.

The automated roulette wheel 110 may be configured to physically spin the roulette wheel, launch a roulette ball, and determine a result. The automated roulette wheel may include a launch system to control roulette ball launch speed and timing, one or more ball change magazines, and on or more sensors to determine a position of the roulette ball during a roulette gaming event. The automated roulette wheel may be a standard roulette wheel having a plurality of symbols and a plurality of pockets each associated with a symbol. Roulette wheel symbols may include at least one of a color, a number, or another design. As such, roulette wheels with alternative designs or numbering may also be applied and operated with the roulette gaming table embodiments discussed herein. Embodiments support both single zero roulette wheels and double zero roulette wheels. A 37-pocket single zero roulette wheel may be used, as well as a 38-pocket with single zero and double zero pockets.

Various embodiments may include multiple wheels, including one or more semi-automatic wheels and automated roulette wheels. A semi-automatic wheel may require at least one manual feature, such as a selection on the dealer console to initiate the spin of the roulette wheel, and a computing device or controller may manage other features, such as a spin speed, a timing of a ball launch, a determination of a result, and similar operational features. An automated wheel may fully automate operational features of the roulette wheel.

The one or more player stations 120 may each include a display, such as an interactive touch screen display, which allows a player to make selections and interact with a gaming interface on the display. The gaming interface may include a betting layout indicating a plurality of symbols and types of bets associated with the automated roulette wheel. The player stations may be arranged around a perimeter of the automated roulette wheel. In some examples, the player stations form a circle around the automated roulette wheel. The one or more player stations may be physically connected and/or wirelessly connected to at least one of the roulette wheel and a cabinet or table supporting the automated roulette wheel. The one or more player stations may be positioned around the automate roulette wheel to allow easy viewing of an event or a result at the automated roulette wheel, and to easily place bets at the interactive gaming interface. Various arrangements of player stations may be possible, depending on space, size, and player considerations.

In some examples, the one or more player stations may include a Radiofrequency Identification (RFID) reader to allow a player to login to a player account. Various interfaces, including live video feeds (e.g., Picture-in-Display (PID)), gaming interfaces, and a tournament display interface, may be interchanged on the display associated with a player station.

At least one computing device may be connected to the one or more player stations and the automated roulette wheel to configure, manage, and operate gameplay. A live video feed of the roulette wheels and spins may be provided on the player display to allow a better view of the gaming events, and to see that the gaming events and results on the interactive interface correspond to the live, physical gaming event at the roulette gaming table.

In examples the player interface includes a PID or a Picture-in-Picture (PIP) live feed of each roulette wheel. In a PID, the live video feed may fill an entire display. In PIP, the live video feed may be provided within a portion of a display, such as on a gaming interface and/or overlaid on another image on the display. In some embodiments, at least one computing device provides, in real time, a live feed of a roulette event at the roulette wheel to the one or more player stations. The player station displays may therefore include a Picture-in-Picture (PIP) or Picture-in-Display (PID) overlay of the automated roulette wheel on a betting layout.

The automated roulette wheel, one or more player stations, and gaming interfaces do not require a live dealer to operate gaming events and wagers. A plurality of players may independently participate and wager on a same roulette gaming event using individual player stations, which may be playable locally or remotely. Other remote gaming options, such as playing on a remote or mobile computing device, may be available as well. The compact shape and footprint of the roulette gaming systems and methods enable space-saving, efficient placement in a gaming location, such as a casino floor, a pit, a stadium, or a gaming arena. Embodiments may therefore maximize space utilization without compromising the gameplay experience.

A display 130 may be provided to provide roulette gaming information to one or more players and attract potential players to the gaming system. In some examples, the display 130 is positioned above the automated roulette wheel 110 in a central position that is easily seen by players at the plurality of player stations 120. The display 130 may include a PIP or PID feed of the automated roulette wheel before, during, or after a roulette gaming event. The display 130 may also indicate multiplier numbers, feature games, such as the golden ball game, as discussed herein, a set of prior winning numbers, animations, results, and other information relating to roulette gaming events occurring at the gaming system.

The roulette gaming system 100 may further include signage 140, which may provide audio and/or visual effects to draw attention to the gaming system and attract players. The signage may be positioned above the automated roulette wheel, and in some examples, above display 130.

The roulette gaming table may include an interior portion, such as a hollow portion providing shelves and/or space for electronics and other items. The interior portion may be accessible via one or more doors that enclose and protect components within the interior portion. At least one door may include a door lock to prevent unauthorized access to the interior portion. Other security features, such as an alarm, an RFID reader, or other sensors (e.g., tilt detection sensors, light sensors, etc.) may be added to protect contents within the gaming cabinet, restrict access, and reduce a risk of damage or theft of one or more components of the roulette gaming system.

The interior portion may include at least one controller for managing aspects of the gaming events, and gaming interfaces. A controller unit may include one or more switches and sensor units for operating any on-table cameras associated with a live feed. In some examples the controller unit may include a switch for turning cameras on and off. A sensor unit may, for example, determine one or more environmental conditions (e.g., lighting) to adjust an aspect of the cameras and the video feed.

A gaming unit may include at least one gaming controller to operate the roulette game. The gaming unit may include software configured to at least provide and manage the dealer interface, player interface(s), a timing of roulette wheel spins and roulette ball launches, a result determination, and a wager resolution. The gaming unit may include multiple computing devices, such as a first computing device to operate and manage gaming aspects related to the first roulette and a second computing device to operate and manage gaming aspects related to the second roulette wheel.

A PIP controller may manage aspects of the one or more visual displays used with roulette gaming table. The PIP controller may include software configured to arrange one or more of images and videos on a player interface and the dealer interface(s). For example, the PIP controller may manage one or more aspects related to video size, position, and resolution on displays. A live video feed, for example, may be provided on a gaming interface, such as overlaid on a betting layout provided on a display on a player station. In some examples, the PIP controller may manage image and video display and placement related to one or more games, jackpots, and tournaments playable with the roulette gaming table. The PIP controller may be wired or wirelessly connected to other electronics components housed within the gaming cabinet. In some examples, the PIP controller is housed external to the gaming cabinet and communicates with one or more displays and player stations wirelessly.

A PID controller may similarly manage aspects of the one or more visual displays used with the roulette gaming table. A PID controller may provide a picture or video within a display. The PID controller may modify picture or video sizing, resolution, position, and other visual characteristics to fit on displays of various sizes. In an example, the PID controller may include software to operate a Tournament game. The Tournament display may provide a unique interface for player devices, through which players may compete against each other during gaming events, such as one or more roulette gaming events. The PID controller may provide additional visual and/or interactive features to connected displays, such as alternate gaming events, advertisements, and information.

A power switch may be provided within the interior portion to turn one or more electronics components on and off. In an example, a main power switch controls power to the displays, cameras, roulette wheels, controllers, and other electronics housed within the gaming cabinet. The power switch may be associated with a power unit that may manage power to and from one or more components of the roulette gaming table.

A door lock may lock a door providing access to the interior portion of the gaming cabinet. The front door lock, as discussed herein, may be a physical lock (e.g., requiring a key), an electronic lock (e.g., requiring a scan of an identification card, a passcode entry, or other form of electronic authorization), a magnetic lock, or any other type of device to secure the interior portion and prevent unauthorized access. Similarly, an interior lock may be provided to secure one or more components within the gaming cabinet, such as a computer or controller box. Additional security features may be implemented, as needed, on or within the gaming cabinet.

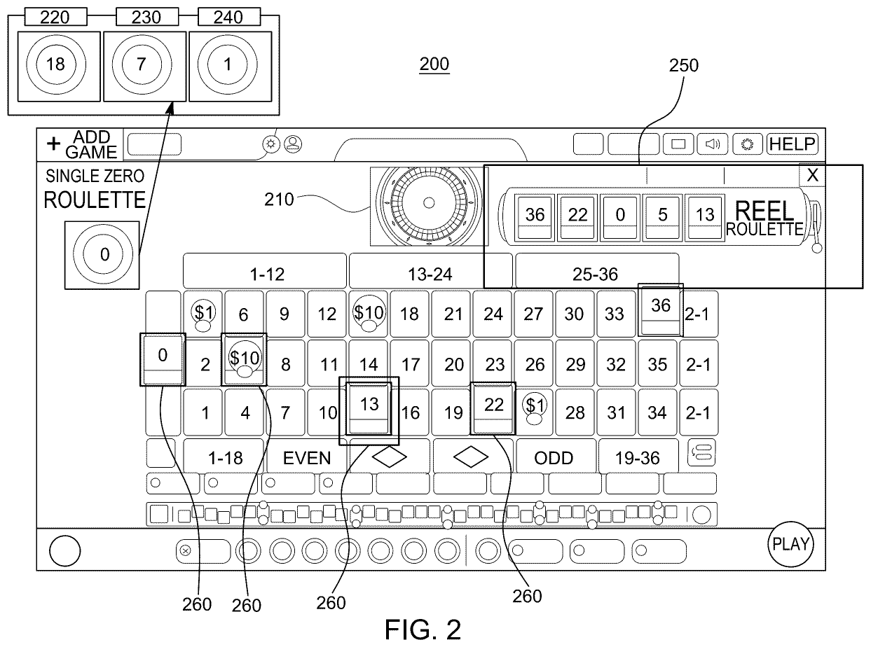

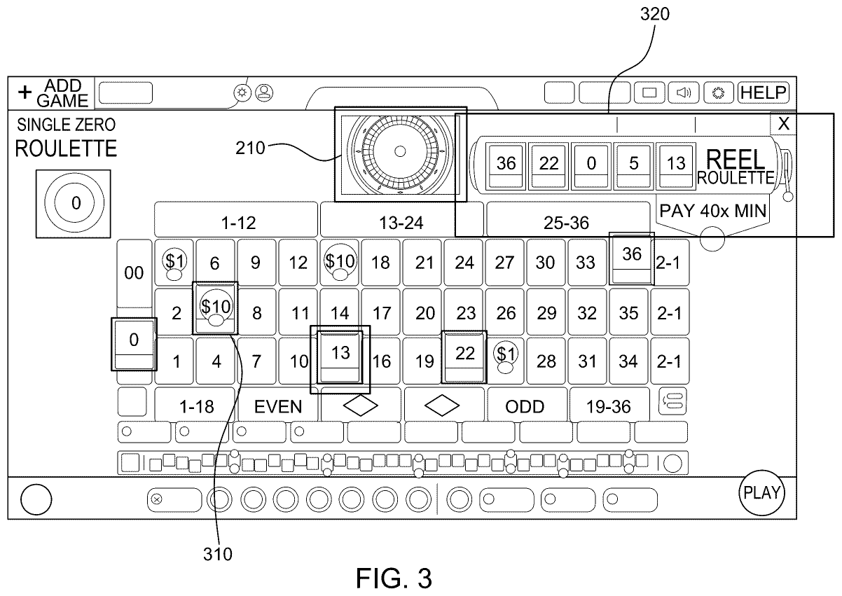

FIG. 2 illustrates an example gaming interface 200 for a standard roulette gaming event. The gaming interface 200 includes a first betting layout displaying betting options associated with the automated roulette wheel. The betting layout may correspond to available numbers and betting options provided on the respective roulette wheel. As discussed herein, the gaming interface supports single zero roulette games and double zero roulette games depending on the type of wheel used for the automated roulette wheel. FIG. 2 illustrates an example interface for a single zero roulette wheels, and FIG. 3 illustrates an example layout for a double zero roulette wheel. The gaming interface may be provided on a display associated with a player station or other player device, such as a mobile computing device, tablet, or laptop.

A PIP display 210 may provide a real time, live video feed of the automated roulette wheel. The live video feed may show all aspects of the gaming event in real-time, including but not limited to, a start of the wheel spin, a roulette ball launch, and a gaming event result, such as when the roulette ball falls into a pocket. The PIP display may be enlarged or minimized using an arrow button. The PIP display may also be moved and locked to a desired position.

Betting indicators 220, 230, 240 may provide information regarding whether a betting window is open or closed, and to help a player to quickly determine where and when to place bets. A first indicator 220 may be provided in a first color (e.g., green) to indicate that a betting window is open. The indicator 220 may also provide text (e.g., “Place Your Bets”) and a time left in the open betting window. A second indicator 230 may be provided in a second color (e.g., yellow) to indicate that a betting window is closing soon. The indicator 230 may also provide text (e.g., “Last Bets Please”) and the time left in the open betting window. A third indicator 240 may be provided in a third color (e.g., red) to indicate that betting window has minimal time left and/or that a betting window is closed. The indicator 240 may also provide text (e.g., “Last Bets Please” or “No More Bets”), any time left in the betting window, or a time until a new betting window is opened. A Win Amount (e.g., $10.00) may be displayed on the interface following a gaming event. The Win Amount may be displayed using one or more colors and animations on the display.

After a betting window has closed, a set of symbols may be randomly selected to be associated with a multiplier value. In an example the set of symbols may be identified on a section of the gaming interface, as seen in reel 250. The symbols may include numbers associated with possible results of the automated roulette wheel. The selected set of symbols may be randomly selected each game, with each game operating independently. In other words, the numbers selected in a first game have no effect on the probability of numbers selected for a second game.

The symbols associated with the set of symbols may be modified on the betting layout to indicate that they are special symbols associated with a multiplier value. In examples, the symbols may be highlighted, animated, enlarged, changed to a different color, or any of a combination of modifications to make those symbols distinct. As seen in FIG. 2, the randomly selected set of symbols to be associated with a multiplier include 36, 22, 0, 5, and 13. The set of symbols are highlighted on the betting layout with a golden box 260, and the associated multiplier value for each symbol is represented both on the betting layout and in the reel 250 in the top right portion of the gaming interface. The remaining symbols in the betting layout may have a straight-up base pay of a certain multiplier value, such as 30:1.

In various embodiments, the multiplier value associated with each symbol in the set of symbols is independently and randomly selected. Gaming events are independent, so both the selected symbols and selected multipliers are randomly drawn each time. In a standard game, as illustrated in FIG. 2, the possible multiplier values may be associated with a first paytable. In a feature game, such as a golden ball game discussed below, the possible multiplier values may be associated with a second paytable. The second paytable may include higher multiplier values than the first paytable. As discussed herein, the standard game and the feature game are distinguished based on a type of ball queued to be launched at the automated roulette wheel. If a standard, e.g., white, roulette ball is queued to be launched next, the standard game with the first paytable of multipliers will be used. If a multiplier ball, e.g., golden, roulette ball is queued to be launched next, the feature game with the second paytable of multipliers will be used.

In some examples, a background of the gaming interface will change, depending on whether the game is a standard game or a feature game. For example, the background of the standard gaming interface may be green and show a standard background, as seen in FIG. 2. The background of the feature game interface may be different, and feature, for example, a red background, and additional colors and animations, as seen in FIG. 3.

FIG. 3 illustrates an example layout for a feature game, also referred to herein as a “Golden Ball” game, in which additional multipliers are provided for a selected set of symbols, and other symbols on the betting layout. The feature game may be triggered based on a type of roulette ball, which may or may not be golden, being used for the gaming event.

The automated roulette wheel may utilize standard roulette balls (e.g., white roulette balls), and a special roulette ball (e.g., a golden ball). Although a golden ball is described herein as being the special roulette ball, other types of roulette balls (e.g., different colors, sizes, features, designs, etc.) may be used to trigger the feature game. The occurrence of the special roulette ball may be associated with a probability, such as 5%, 10%, 15%, or another value, which may be changed. The selection of the special roulette ball may trigger a second paytable to be associated with the randomly selected set of symbols.

In an example feature game, the straight up odds may be increased, e.g., 30×-40×, for all numbers without multipliers. The multiplier values may increase from 200×-400× (in the standard game) to 400×-500× in the feature game. In some examples, multipliers for the standard game may range from 50×-200× (e.g., 40×, 50×, 100×, 150×, 200×, etc.) and multipliers for the feature game may range from 50×-1000× (e.g., 50×, 100×, 150×, 200×, 250×, 500×, 1000×, etc.). The paytables associated with each game type may assign weights to different multiplier values.

In the example shown in FIG. 3, the randomly drawn set of symbols are 36, 22, 0, 5, and 13. As noted on the reel 320, all straight bets pay 40× minimum, and the selected set of symbols are associated with respective multiplier values of 100×, 250×, 1000×, 500×, and 50×. Although each of the randomly selected symbols is shown with a different multiplier, as the multipliers are randomly drawn, it is possible that two or more symbols may have the same multiplier. The selected set of symbols may be modified on the main betting layout as seen in the box 310 surrounding the number 5. The chip on the number indicates that the player has placed a $10 bet on the number 5. Since the number 5 is associated with a 500× multiplier, the payout value will be 500× the standard payout.

The gaming interfaces, as illustrated in FIGS. 2-3, may include additional gameplay features, options, and modifications to enhance player experience, and enable a player to customize their gaming experience. For example, a top bar of the player interface may provide a summary regarding the roulette game and one or more quick-action selections. The top bar may indicate credits, including a “Credit” box indicating a total number of credits, e.g., related to a player account, and a “Playable” box indicating an amount of credits that the player can bet. A “Cash Out” button enables a player to cash out and receive any player credits via ticket printer, a credit add to a player account, or a cash pay out from a dealer. The Cash Out selection may only be available when no bets are currently on the table.

Configurable selections may be provided to enable a player to customize a view of the player interface. For example, an opacity button may be provided to enable a player to reduce the visibility of the player's credits, last bet(s), and the playable amount. A “Main Information” display may provide gaming information, such as when a betting window opens, a time left in the betting window, and when a betting window closes. Error messages may also be provided. A “Call Attendant” or “Concierge” button may signal an attendant of the gaming device, an attendant on the casino floor, or another individual associated with the gaming location and assisting players. A “Flag” button may indicate a language used on the interface, and a selection of the button may enable a player to change the interface language. An “Options” button may bring up a menu that includes additional information about the gameplay or the device. In some examples, the Options menu may include “Show Winnings,” which will display, as the user places bets, possible winnings for each bet. The possible winnings may be enabled or disabled using a slider or other toggle button. A “Number Orientation” option will allow a player to set a desired number orientation on the roulette table view to be vertical or horizontal. A “Show Bet Limits” option will change a display of the roulette table to a display of bet limits for different wagering options. A “Reserve Table” option allows players to reserve a player station for a period of time. A “Help/Rules” option displays a help screen.

Betting information may be provided for the roulette gaming event. The betting information may indicate a Bet, Last Win, and Last Bet information. A Display Adjustment button allows a player to adjust their gaming layout. A history bar may display the last pre-set number of wins corresponding to the roulette wheel.

A betting table may provide a betting layout including betting fields arranged similarly to a live table. The betting table may include betting options and combinations. Players may choose one or more selections to assign a bet.

A bet timer may provide an indication of whether a betting window is open or closed and may provide a time left for a player to place a bet. A Statistics button may be provided on each betting layout to see respective gaming statistics for each roulette wheel.

A “Special Bets” button may be provided on each betting layout to bring up additional betting combinations for roulette. Such betting combinations may include but are not limited to Single Zero, Double Zero, Triple Zero, Neighbors of (Big) Zero, Small Series, Orphans, Final, Complete, Red Snake, Red Splits, Black Splits, and Neighbors.

A Wheel Bet View button may change the table layout to a wheel bet view, where numbers are placed in a circular order as they appear on the roulette wheel. In the wheel bet layout, players may place bets only on single numbers.

Controls may enable Denomination, Chips, and Game Controls for each respective layout. A Denomination control sets the value of one credit and hence the value of the game. The selected value of one credit may be displayed on the denomination button. The Chips control enables players to select and place chips of different values on the table. Values assigned to chips may be defined with the selected denomination. In some examples, if multi-denomination is disabled, only chips may be available. The Game Control selection may include features to Clear Last Bet, Clear All Bets, Double Bet, Repeat Last Bet, Game Chips, and Fast Bet (i.e., selecting multiple options by dragging a finger across desired fields).

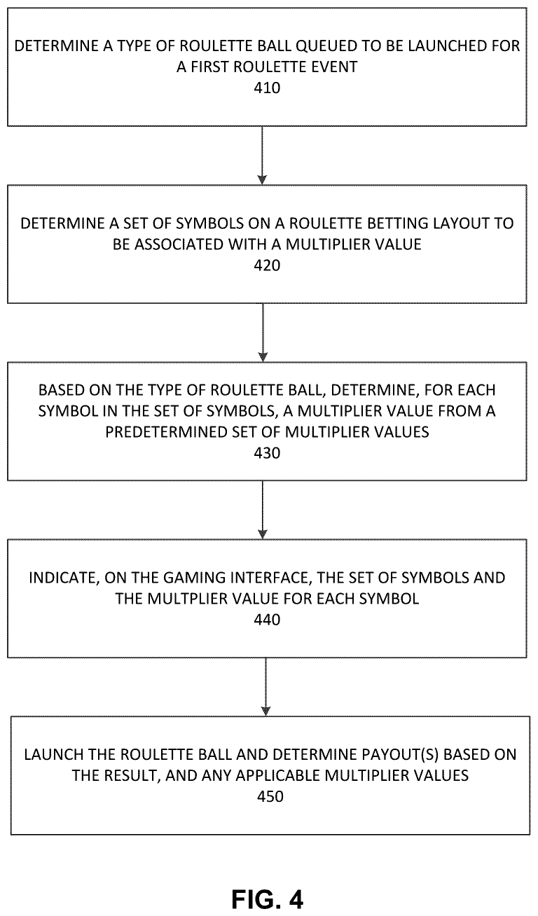

FIG. 4 illustrates an example game flow for a roulette gaming event. In various examples, one or more computing device may communicate with the player stations and the automated roulette wheel, to provide real-time, consistent information on the gaming interfaces, and to resolve bets. One or more of the following aspects may occur after a betting window has closed for a gaming event. In other words, the randomly selected set of symbols and associated multipliers are determined after bet selections have been made on any active gaming interfaces at the player stations.

At box 410, aspects may determine a type of roulette ball queued to be launched for a first roulette event. An occurrence of a special roulette ball, such as a golden ball, to trigger the feature game may be associated with a probability, such as 5%, 10%, 15%, or 20%. Gaming events are independent such that an outcome or occurrence of type of roulette ball in a first gaming event has no effect on subsequent gaming events. The type of roulette ball may be determined, for example, using a random number generator.

At box 420, aspects may determine a set of symbols on a roulette betting layout to be associated with a multiplier value. The set of symbols may be a subset of available symbols on the betting layout. For example, in a betting layout with 37 numerical options, the set of symbols may be selected from those 37 options. The set of symbols may be one, two, three, four, five, or more symbols. The set of symbols are randomly determined.

At box 430, aspects may, based on the type of roulette ball, determine, for each symbol in the set of symbols, a multiplier value from a predetermined set of multiplier values. As discussed herein, a standard roulette ball may trigger a set of available multipliers associated with a first paytable, and a special roulette ball, such as the golden ball, may trigger a second set of available multipliers associated with a second paytable. The available multipliers in the first paytable may generally be less than the available multipliers in the second paytable.

At box 440, aspects may indicate, on the gaming interface, the set of symbols and the multiplier value for each symbol. The set of symbols may be displayed on the gaming interface on the one or more player stations, for example, in a reel on an upper right portion of the gaming interface. The set of symbols may be modified, highlighted, enlarged, animated, or otherwise distinguished from other symbols on the betting layout, and indicate a multiplier value associated with the symbol.

At box 450, aspects may launch the roulette ball and determine any payouts based on the result and any applicable multiplier values. If the result matches a symbol in the set of symbols, and the player has placed a bet on the symbol, then the standard payout amount will be multiplied by the multiplier value. If the result matches a symbol that is not in the set of symbols, and the player has placed a bet on the symbol, then the standard payout applies.

In a feature game, special multipliers may be applied to all numbers, such that winning selections receive a minimum multiplier amount. For example, in a golden ball game, all straight bets receive a 40× payout. If the winning number is also in the reel, the payout is multiplied by the multiplier value associated with the number.

The present disclosure describes particular embodiments and their detailed construction and operation. The embodiments described herein are set forth by way of illustration only and not limitation. Those skilled in the art will recognize, in light of the teachings herein, that there may be a range of equivalents to the exemplary embodiments described herein. Most notably, other embodiments are possible, variations can be made to the embodiments described herein, and there may be equivalents to the components, parts, or steps that make up the described embodiments. For the sake of clarity and conciseness, certain aspects of components or steps of certain embodiments are presented without undue detail where such detail would be apparent to those skilled in the art in light of the teachings herein and/or where such detail would obfuscate an understanding of more pertinent aspects of the embodiments.

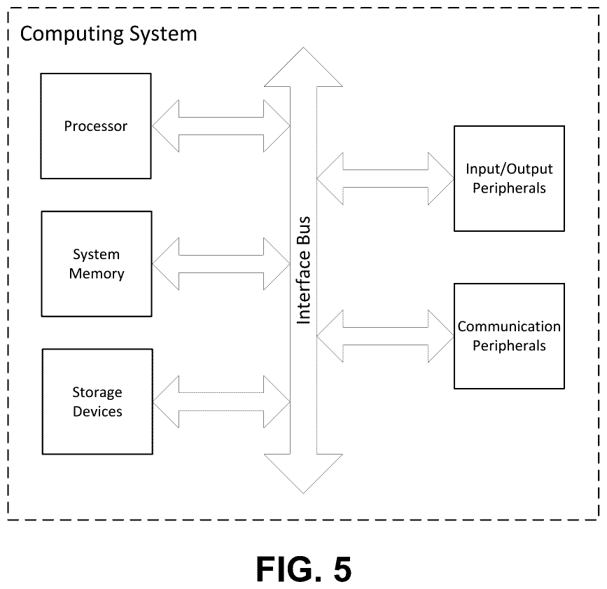

The techniques described above can be implemented on a computing device associated with a gaming device (e.g., a roulette machine operating a live roulette game), a plurality of computing devices associated with a plurality of gaming devices, a controller in communication with the gaming device(s) (e.g., a controller configured to synchronize the gaming devices(s)), or a plurality of controllers in communication with the gaming device(s). Additionally, the techniques may be distributed between the computing device(s) and the controller(s). FIG. 5 illustrates an exemplary block diagram of a computing system that includes hardware modules, software module, and a combination thereof and that can be implemented as the computing device and/or as the server.

In a basic configuration, the computing system may include at least a processor, a system memory, a storage device, input/output peripherals, communication peripherals, and an interface bus. Instructions stored in the memory may be executed by the processor to perform a variety of methods and operations, including the roulette wheel velocity adjustments and result detection optimization, as described above. The computing system components may be present in the gaming device, in a server or other component of a network, or distributed between some combinations of such devices.

The interface bus is configured to communicate, transmit, and transfer data, controls, and commands between the various components of the electronic device. The system memory and the storage device comprise computer readable storage media, such as RAM, ROM, EEPROM, hard-drives, CD-ROMs, optical storage devices, magnetic storage devices, flash memory, and other tangible storage media. Any of such computer readable storage medium can be configured to store instructions or program codes embodying aspects of the disclosure. Additionally, the system memory comprises an operation system and applications. The processor is configured to execute the stored instructions and can comprise, for example, a logical processing unit, a microprocessor, a digital signal processor, and the like.

The system memory and the storage device may also comprise computer readable signal media. A computer readable signal medium may include a propagated data signal with computer readable program code embodied therein. Such a propagated signal may take any of variety of forms including, but not limited to, electro-magnetic, optical, or any combination thereof. A computer readable signal medium may be any computer readable medium that is not a computer readable storage medium and that can communicate, propagate, or transport a program for use in connection with the computing system.

Further, the input and output peripherals include user interfaces such as a keyboard, screen, microphone, speaker, other input/output devices, and computing components such as digital-to-analog and analog-to-digital converters, graphical processing units, serial ports, parallel ports, and universal serial bus. The input/output peripherals may also include a variety of sensors, such as light, proximity, GPS, magnetic field, altitude, and velocity/acceleration. RSSI, and distance sensors, as well as other types of sensors. The input/output peripherals may be connected to the processor through any of the ports coupled to the interface bus.

The user interfaces can be configured to allow a user of the computing system to interact with the computing system. For example, the computing system may include instructions that, when executed, cause the computing system to generate a user interface and carry out other methods and operations that the user can use to provide input to the computing system and to receive an output from the computing system.

This user interface may be in the form of a graphical user interface that is rendered at the screen and that is coupled with audio transmitted on the speaker and microphone and input received at the keyboard. In an embodiment, the user interface can be locally generated at the computing system. In another embodiment, the user interface may be hosted on a remote computing system and rendered at the computing system. For example, the server may generate the user interface and may transmit information related thereto to the computing device that, in turn, renders the user interface to the user. The computing device may, for example, execute a browser or an application that exposes an application program interface (API) at the server to access the user interface hosted on the server.

Finally, the communication peripherals of the computing system are configured to facilitate communication between the computing system and other computing systems (e.g., between the computing device and the server) over a communications network. The communication peripherals include, for example, a network interface controller, modem, various modulators/demodulators and encoders/decoders, wireless and wired interface cards, antenna, and the like.

The communication network includes a network of any type that is suitable for providing communications between the computing device and the server and may comprise a combination of discrete networks which may use different technologies. For example, the communications network includes a cellular network, a Wi-Fi/broadband network, a local area network (LAN), a wide area network (WAN), a telephony network, a fiber-optic network, or combinations thereof. In an example embodiment, the communication network includes the Internet and any networks adapted to communicate with the Internet. The communications network may be also configured as a means for transmitting data between the computing device and the server.

The techniques described above may be embodied in, and fully or partially automated by, code modules executed by one or more computers or computer processors. The code modules may be stored on any type of non-transitory computer-readable medium or computer storage device, such as hard drives, solid state memory, optical disc, and/or the like. The processes and algorithms may be implemented partially or wholly in application-specific circuitry. The results of the disclosed processes and process steps may be stored, persistently or otherwise, in any type of non-transitory computer storage such as, e.g., volatile, or non-volatile storage.

In an embodiment, a roulette gaming system, comprising: an automated roulette wheel configured to launch a roulette ball and determine a result; a plurality of player stations arranged around a perimeter of the automated roulette wheel, wherein each player station comprises a display; at least one computing device in communication with the automated roulette wheel and the plurality of player stations, the computing device comprising a processor and a memory, the memory comprising instructions, which when executed by the processor, cause the computing device to: provide, on a first display of a first player station, a gaming interface to enable a player to wager on roulette events at the automated roulette wheel, wherein the gaming interface provides a betting layout for a first roulette gaming event, and wherein the betting layout comprises available outcomes associated with the automated roulette wheel; set a betting window defining a time to accept bets from the plurality of player stations; receive, via a selection at the first player station, a first bet wagering on an outcome of a first roulette event; determine a type of roulette ball queued to be launched for the first roulette event; determine a set of symbols on the betting layout to be associated with a multiplier value from a predetermined set of multipliers; when the type of roulette ball is determined to be a standard roulette ball: for each symbol in the set of symbols, determine a multiplier value from a predetermined set of multipliers associated with a first paytable; when the type of roulette ball is determined to be a multiplier ball: for each symbol in the set of symbols, determine a multiplier value from a predetermined set of multipliers associated with a second paytable; indicate, on the gaming interface, the set of symbols and the multiplier value for each symbol; launch the roulette ball to determine the result; and determine a payout for the first bet based on the result and the multiplier value associated with the symbol.

In an embodiment, wherein the set of symbols and the multiplier value for each symbol are independently, randomly determined.

In an embodiment, wherein the type of roulette ball, the set of symbols, and the multiplier value for each symbol in the set of symbols are independently determined for each gaming event.

In an embodiment, wherein a probability for the multiplier ball is less than 20%.

In an embodiment, wherein the set of symbols comprise five symbols, the predetermined set of values associated with the first paytable comprise values of 30×-200×, and the predetermined set of multipliers associated with the second paytable comprise values of 40×-500×.

In an embodiment, wherein when the type of roulette ball is determined to be a multiplier ball, increase a payout value for betting layout symbols that are not in the set of symbols by at least 30×.

In an embodiment, wherein the betting window closes before the set of symbols and the multiplier values are determined.

In an embodiment, wherein the standard roulette ball is a white roulette ball, and the multiplier roulette ball is a golden roulette ball.

In an embodiment, wherein the computing device is further configured to: provide a live video feed of the automated roulette wheel on the gaming interface.

In an embodiment, wherein the automated roulette wheel comprises a plurality of pockets to receive the roulette ball, and at least one of a 0 pocket and a 00 pocket.

In an embodiment, wherein the automated roulette wheel comprises at least 37 pockets.

In an embodiment, wherein the gaming interface provides an indication for at least one of: a time left to accept bets, no more bets, and gaming event results.

In an embodiment, wherein the gaming interface displays the result of the gaming event, in real-time.

In an embodiment, a method for playing roulette, comprising: providing, on a first display of a first player station, a gaming interface configured to enable a player to wager on roulette events at an automated roulette wheel, wherein the automated roulette wheel is configured to launch a roulette ball and determine a result, wherein the gaming interface provides a betting layout for a first roulette gaming event, and wherein the betting layout comprises available outcomes associated with the automated roulette wheel; setting a betting window defining a time to accept bets from the plurality of player stations; receiving, via a selection at the first player station, a first bet wagering on an outcome of a first roulette event; determining a type of roulette ball queued to be launched for the first roulette event; determining a set of symbols on the betting layout to be associated with a multiplier value from a predetermined set of multipliers; when the type of roulette ball is determined to be a standard roulette ball: for each symbol in the set of symbols, determining a multiplier value from a predetermined set of multipliers associated with a first paytable; when the type of roulette ball is determined to be a multiplier ball: for each symbol in the set of symbols, determining a multiplier value from a predetermined set of multipliers associated with a second paytable; indicating, on the gaming interface, the set of symbols and the multiplier value for each symbol; launching the roulette ball to determine the result; and determining a payout for the first bet based on the result and the multiplier value associated with the symbol.

In an embodiment, further comprising displaying an animation and changing a background of the gaming interface when the type of roulette ball is determined to be a multiplier ball.

In an embodiment, wherein the set of symbols and the multiplier values are highlighted on the betting layout on the gaming interface.

In an embodiment, a non-transitory computer readable medium comprising instructions stored thereon, which when executed by a processor, cause a computing device to: provide, on a first display of a first player station, a gaming interface configured to enable a player to wager on roulette events at an automated roulette wheel, wherein the automated roulette wheel is configured to launch a roulette ball and determine a result, wherein the gaming interface provides a betting layout for a first roulette gaming event, and wherein the betting layout comprises available outcomes associated with the automated roulette wheel; set a betting window defining a time to accept bets from the plurality of player stations; receive, via a selection at the first player station, a first bet wagering on an outcome of a first roulette event; determine a type of roulette ball queued to be launched for the first roulette event; determine a set of symbols on the betting layout to be associated with a multiplier value from a predetermined set of multipliers; when the type of roulette ball is determined to be a standard roulette ball: for each symbol in the set of symbols, determine a multiplier value from a predetermined set of multipliers associated with a first paytable; when the type of roulette ball is determined to be a multiplier ball: for each symbol in the set of symbols, determine a multiplier value from a predetermined set of multipliers associated with a second paytable; indicate, on the gaming interface, the set of symbols and the multiplier value for each symbol; launch the roulette ball to determine the result; and determine a payout for the first bet based on the result and, the multiplier value associated with the symbol.

In an embodiment, further comprising instructions to display a live feed of the automated roulette wheel on the gaming interface and display an animation to indicate the set of symbols and multiplier values on the betting layout.

In an embodiment, wherein the betting window closes before the set of symbols and the multiplier values are determined, and the multiplier value for each symbol is independently and randomly determined from the predetermined set of multipliers.

In an embodiment, wherein predetermined set of multipliers comprise values of 30×-200× for gaming events associated with the standard roulette ball, and values of 40×-100× for gaming events associated with the multiplier ball.

Conditional language used herein, such as, among others, “can,” “could,” “might,” “may,” “e.g.,” and the like, unless specifically stated otherwise, or otherwise understood within the context as used, is generally intended to convey that certain embodiments include, while other embodiments do not include, certain features, elements, and/or steps. Thus, such conditional language is not generally intended to imply that features, elements and/or steps are in any way required for one or more embodiments or that one or more embodiments necessarily include logic for deciding, with or without author input or prompting, whether these features, elements and/or steps are included or are to be performed in any particular embodiment. The terms “comprising,” “including,” “having,” and the like are synonymous and are used inclusively, in an open-ended fashion, and do not exclude additional elements, features, acts, operations, and so forth. Also, the term “or” is used in its inclusive sense (and not in its exclusive sense) so that when used, for example, to connect a list of elements, the term “or” means one, some, or all of the elements in the list.

The present disclosure describes particular embodiments and their detailed construction and operation. The embodiments described herein are set forth by way of illustration only and not limitation. Those skilled in the art will recognize, in light of the teachings herein, that there may be a range of equivalents to the exemplary embodiments described herein. Most notably, other embodiments are possible, variations can be made to the embodiments described herein, and there may be equivalents to the components, parts, or steps that make up the described embodiments. For the sake of clarity and conciseness, certain aspects of components or steps of certain embodiments are presented without undue detail where such detail would be apparent to those skilled in the art in light of the teachings herein and/or where such detail would obfuscate an understanding of more pertinent aspects of the embodiments.

The terms and descriptions used above are set forth by way of illustration only and are not meant as limitations. Those skilled in the art will recognize that those and many other variations, enhancements and modifications of the concepts described herein are possible without departing from the underlying principles of the invention. The scope of the invention should therefore be determined only by the following claims and their equivalents.

What is claimed is:

1. A roulette gaming system, comprising:
an automated roulette wheel configured to launch a roulette ball and determine a result;
a plurality of player stations arranged around a perimeter of the automated roulette wheel, wherein each player station comprises a display;
at least one computing device in communication with the automated roulette wheel and the plurality of player stations, the computing device comprising a processor and a memory, the memory comprising instructions, which when executed by the processor, cause the computing device to:
provide, on a first display of a first player station, a gaming interface to enable a player to wager on roulette events at the automated roulette wheel, wherein the gaming interface provides a betting layout for a first roulette gaming event, and wherein the betting layout comprises available outcomes associated with the automated roulette wheel;
set a betting window defining a time to accept bets from the plurality of player stations;
receive, via a selection at the first player station, a first bet wagering on an outcome of a first roulette event;
determine a type of roulette ball queued to be launched for the first roulette event;
determine a set of symbols on the betting layout to be associated with a multiplier value from a predetermined set of multipliers;
when the type of roulette ball is determined to be a standard roulette ball: for each symbol in the set of symbols, determine a multiplier value from a predetermined set of multipliers associated with a first paytable;
when the type of roulette ball is determined to be a multiplier ball: for each symbol in the set of symbols, determine a multiplier value from a predetermined set of multipliers associated with a second paytable;
indicate, on the gaming interface, the set of symbols and the multiplier value for each symbol;
launch the roulette ball to determine the result; and
determine a payout for the first bet based on the result and the multiplier value associated with the symbol.

2. The roulette gaming system of claim 1, wherein the set of symbols and the multiplier value for each symbol are independently, randomly determined.

3. The roulette gaming system of claim 1, wherein the type of roulette ball, the set of symbols, and the multiplier value for each symbol in the set of symbols are independently determined for each gaming event.

4. The roulette gaming system of claim 3, wherein a probability of when the type of roulette ball will be determined to be the multiplier ball is less than 20%.

5. The roulette gaming system of claim 1, wherein the set of symbols comprise five symbols, the predetermined set of values associated with the first paytable comprise values of 30×-200×, and the predetermined set of multipliers associated with the second paytable comprise values of 40×-500×.

6. The roulette gaming system of claim 1, wherein when the type of roulette ball is determined to be a multiplier ball, increase a payout value for betting layout symbols that are not in the set of symbols by at least 30×.

7. The roulette gaming system of claim 1, wherein the betting window closes before the set of symbols and the multiplier values are determined.

8. The roulette gaming system of claim 1, wherein the standard roulette ball is a white roulette ball, and the multiplier roulette ball is a golden roulette ball.

9. The roulette gaming system of claim 1, wherein the computing device is further configured to: provide a live video feed of the automated roulette wheel on the gaming interface.

10. The roulette gaming system of claim 1, wherein the automated roulette wheel comprises a plurality of pockets to receive the roulette ball, and at least one of a 0 pocket and a 00 pocket.

11. The roulette gaming system of claim 1, wherein the automated roulette wheel comprises at least 37 pockets.

12. The roulette gaming system of claim 1, wherein the gaming interface provides an indication for at least one of: a time left to accept bets, no more bets, and gaming event results.

13. The roulette gaming system of claim 1, wherein the gaming interface displays the result of the gaming event, in real-time.

14. A method for playing roulette, comprising:
providing, on a first display of a first player station, a gaming interface configured to enable a player to wager on roulette events at an automated roulette wheel, wherein the automated roulette wheel is configured to launch a roulette ball and determine a result, wherein the gaming interface provides a betting layout for a first roulette gaming event, and wherein the betting layout comprises available outcomes associated with the automated roulette wheel;
setting a betting window defining a time to accept bets from the plurality of player stations;
receiving, via a selection at the first player station, a first bet wagering on an outcome of a first roulette event;
determining a type of roulette ball queued to be launched for the first roulette event;
determining a set of symbols on the betting layout to be associated with a multiplier value from a predetermined set of multipliers;
when the type of roulette ball is determined to be a standard roulette ball: for each symbol in the set of symbols, determining a multiplier value from a predetermined set of multipliers associated with a first paytable;
when the type of roulette ball is determined to be a multiplier ball: for each symbol in the set of symbols, determining a multiplier value from a predetermined set of multipliers associated with a second paytable;
indicating, on the gaming interface, the set of symbols and the multiplier value for each symbol;
launching the roulette ball to determine the result; and
determining a payout for the first bet based on the result and the multiplier value associated with the symbol.

15. The method of claim 14, further comprising displaying an animation and changing a background of the gaming interface when the type of roulette ball is determined to be a multiplier ball.

16. The method of claim 14, wherein the set of symbols and the multiplier values are highlighted on the betting layout on the gaming interface.

17. A non-transitory computer readable medium comprising instructions stored thereon, which when executed by a processor, cause a computing device to:
provide, on a first display of a first player station, a gaming interface configured to enable a player to wager on roulette events at an automated roulette wheel, wherein the automated roulette wheel is configured to launch a roulette ball and determine a result, wherein the gaming interface provides a betting layout for a first roulette gaming event, and wherein the betting layout comprises available outcomes associated with the automated roulette wheel;
set a betting window defining a time to accept bets from the plurality of player stations;
receive, via a selection at the first player station, a first bet wagering on an outcome of a first roulette event;
determine a type of roulette ball queued to be launched for the first roulette event;
determine a set of symbols on the betting layout to be associated with a multiplier value from a predetermined set of multipliers;
when the type of roulette ball is determined to be a standard roulette ball: for each symbol in the set of symbols, determine a multiplier value from a predetermined set of multipliers associated with a first paytable;
when the type of roulette ball is determined to be a multiplier ball: for each symbol in the set of symbols, determine a multiplier value from a predetermined set of multipliers associated with a second paytable;
indicate, on the gaming interface, the set of symbols and the multiplier value for each symbol;
launch the roulette ball to determine the result; and
determine a payout for the first bet based on the result and the multiplier value associated with the symbol.

18. The non-transitory computer readable medium of claim 17, further comprising instructions to display a live feed of the automated roulette wheel on the gaming interface and display an animation to indicate the set of symbols and multiplier values on the betting layout.

19. The non-transitory computer readable medium of claim 17, wherein the betting window closes before the set of symbols and the multiplier values are determined, and the multiplier value for each symbol is independently and randomly determined from the predetermined set of multipliers.

20. The non-transitory computer readable medium of claim 17, wherein predetermined set of multipliers comprise values of 30×-200× for gaming events associated with the standard roulette ball, and values of 40×-100× for gaming events associated with the multiplier ball.
